(19) United States
(12) Patent Application Publication
(10) Pub. No.: US 2006/0245510 A1
(43) Pub. Date: Nov. 2, 2006

(54) Radio communication system, radio communication apparatus, receiving apparatus, and radio communication method

(75) Inventor: Kengo Oketani, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION

(21) Appl. No.: 11/411,055

(22) Filed: Apr. 26, 2006

(30) Foreign Application Priority Data
Apr. 28, 2005 (JP) 131575/2005

(51) Int. Cl. H04K 1/10

(52) U.S. Cl. 375/260

(57) ABSTRACT

A radio communication system, a radio communication apparatus, receiving apparatus and radio communication method are provided herein. The radio communication system may include a transmitting Unit which includes a mapping circuit which generates a data channel which has a known value inserted in idle subcarriers, a transmitter which transmits a radio signal including the data channel. And the radio communication system may also include a receiving unit which includes a receiver which receives the radio signal from the transmitting unit and an interference eliminator which eliminates a delayed wave component from the data channel based on the known value inserted in the idle subcarriers.

### CROSS-REFERENCE TO RELATED PATENT APPLICATION

This application claims the benefit of Japanese Patent Application No. 131575/2005, filed on Apr. 28, 2005, in the Japanese Patent Office, the disclosure of which is incorporated herein in its entirety by reference.

### BACKGROUND OF THE INVENTION

The present invention relates to a radio communication system, a radio communication apparatus, receiving apparatus and radio communication method for the Orthogonal Frequency Division Multiplexing (OFDM) modulation system, and more particularly to a technique for reducing interblock interference caused by a delayed wave.

In recent years, the OFDM (Orthogonal Frequency Division Multiplexing) modulation system is attracting attention in the field of radio communication such as mobile communication.

Generally, in a radio communication system, a delayed wave may be caused by multipaths due to the environment of the propagation path. In a radio communication system using OFDM, to eliminate the influence of such a delayed wave, a guard interval (GI) is periodically added to a transmit signal. A GI may have a predetermined time period. An OFDM transmitting apparatus segments data into blocks of a predetermined size and adds a GI between the blocks and transmits the resultant data.

When a delay of the delayed wave is equal to or smaller than the time period of the GI, a signal from the adjacent block leaks only to the GI and does not leak to the block, thereby the interblock interference does not occur. More specifically, it can be said that an OFDM radio communication system has tolerance to a multipath interference caused by a delay equal to or smaller than the GI.

However, as the length of the GI is increased, transmission efficiency becomes lower. Thus, in an actual system, a balance between transmission efficiency and tolerance to multipath interference is considered when determining a GI. Accordingly, a delay caused by multipaths may exceed a GI due to the actual environment of propagation path. In this case, interblock interference occurs, and thus, orthogonality between subcarriers within a block is lost, causing a large characteristic degradation.

To solve this problem, teachings have been proposed for reducing the influence of a delayed wave exceeding a GI (for example, refer to Japanese Patent Laid-Open Patent No. 2004-208254, paragraph No. 0020). The communication apparatus described in Japanese Patent Laid-Open Patent No. 2004-208254 measures a maximum delay time from a pilot channel and checks whether or not a delayed wave exceeding a GI exists. If so, the communication apparatus calculates an interference component reaching a subsequent block based on a known pilot sequence and a channel estimation value, and subtracts the interference component from the subsequent block. In this manner, the communication apparatus reduces the influence of a delayed wave exceeding a GI.

However, the communication apparatus of the prior art estimates the interference component by using the preceding block and eliminates the interference component by subtracting the component from the block. Therefore, an error could be conveyed to the subsequent block and the quality of the communication may be deteriorated.

### SUMMARY OF THE INVENTION

One of the objects of the present invention is to provide a radio communication system capable of satisfactorily reducing the influence of a delayed wave.

According to an aspect of the present invention, the transmitting apparatus transmits a signal obtained by inserting a known value in idle subcarriers, and the receiving apparatus eliminates a delayed wave component from a received signal by utilizing the presence of the idle subcarriers having the known value inserted therein. Accordingly, interference caused by a delayed wave is determined based on leakage into idle subcarriers originally having a known value, and interference can thus be satisfactorily eliminated.

According to another aspect of the invention, the radio communication system includes, a transmitting unit which includes, a mapping circuit which generates a data channel, which has a known value inserted in idle subcarriers, and a transmitter, which transmits a radio signal including the data channel, and a receiving unit which includes, a receiver, which receives the radio signal from the transmitting unit and

an interference eliminator which eliminates a delayed wave component from the data channel based on the known value inserted in the idle subcarriers.

According to another aspect of the invention, the radio communication apparatus includes, a transmitting unit, which includes a mapping circuit which generates a data channel, which has a known value inserted in idle subcarriers, and a transmitter, which transmits a radio signal including the data channel, and a receiving unit, which includes a receiver, which receives the radio signal from the transmitting unit and an interference eliminator which eliminates a delayed wave component from the data channel based on the known value inserted in the idle subcarriers.

According to another aspect of the invention, the receiving apparatus includes, a receiver, which receives a radio signal including a data channel in which a known value in subcarriers is inserted, a determination unit, which determines., based on a delay time of a delayed wave of the radio signal from a transmitting apparatus, whether or not to perform interference elimination, and an interference eliminator, which eliminates, in response to the result of the determination unit, a delayed wave component of the data channel by an interference elimination process using the known value inserted in the idle subcarriers.

According to another aspect of the invention, the radio communication method includes, generating a data channel, which has a known value inserted in idle subcarriers, transmitting a radio signal including the data channel, receiving the radio signal and eliminating a delayed wave component from the data channel based on the known value inserted in the idle subcarriers.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram showing a configuration of a radio communication system according to a first exemplary embodiment.

FIG. 2 is a block diagram showing a configuration of a radio communication apparatus according to the first exemplary embodiment.

FIG. 3 is a view for explaining the process of a transmitting unit according to the first exemplary embodiment.

FIG. 4 is a view for explaining the operation of a block segmentation/subcarrier mapping unit according to the first exemplary embodiment.

FIG. 5 is a view for explaining the process of adding a GI.

FIG. 6 is a flowchart showing an example of interference elimination operation by a receiving unit of the radio communication apparatus according to the present exemplary embodiment.

FIG. 7 is a block diagram showing a configuration of a radio communication apparatus according to a second exemplary embodiment.

FIG. 8 is a block diagram showing a configuration of a radio communication apparatus according to a fourth exemplary embodiment.

### DETAILED DESCRIPTION OF EXEMPLARY EMBODIMENTS

Hereinafter, exemplary embodiments of the present invention will now be described in detail with reference to the accompanying drawings. The described exemplary embodiments are intended to assist in understanding the invention, and are not intended to limit the scope of the invention in any way.

Exemplary embodiments of the present invention will be described in detail with reference to the drawings.

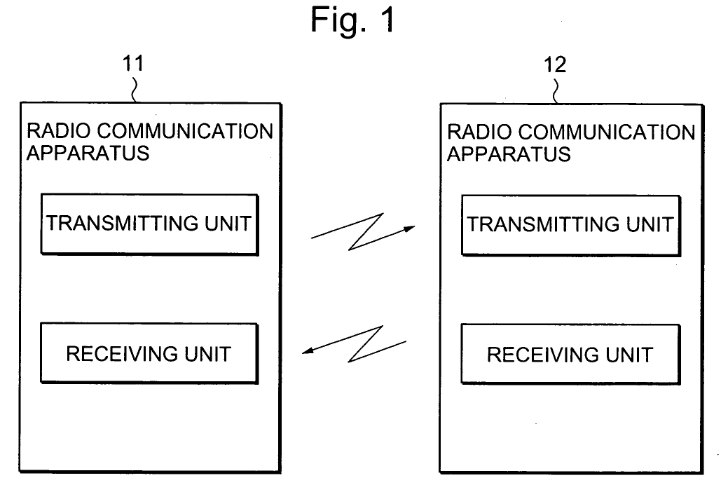

FIG. 1 is a block diagram showing a configuration of a radio communication system according to a first exemplary embodiment. Referring to FIG. 1, the radio communication system according to the first exemplary embodiment includes radio communication apparatuses 11 and 12. According to the present exemplary embodiment, by way of example, the radio communication apparatuses 11 and 12 have the same configuration and bilaterally communicate with each other in the OFDM (Orthogonal Frequency Division Multiplexing) modulation system. A radio communication apparatus 11, 12 may be a cellular phone, a Personal Digital Assistant (PDA), a Personal Computer (PC) and the like which utilizes the OFDM modulation technology.

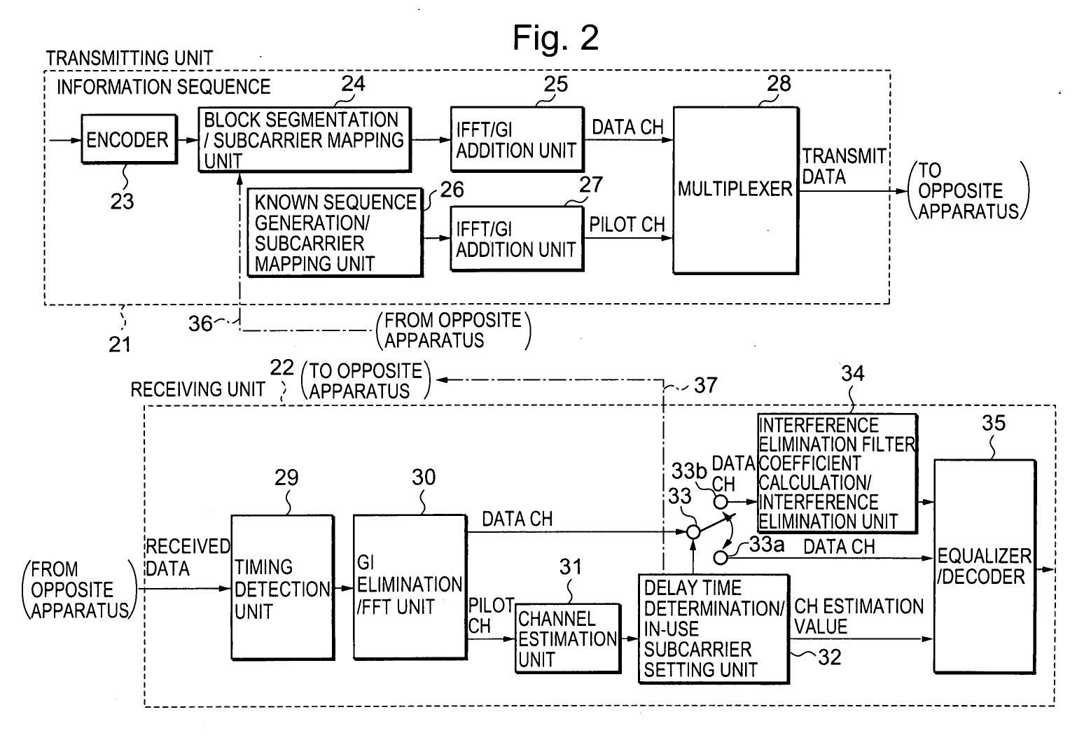

FIG. 2 is a block diagram showing a configuration of a radio communication apparatus according to the first exemplary embodiment. The radio communication apparatuses 11 and 12 have the same configuration, and hence the radio communication apparatus 11 is shown here as representative.

Referring to FIG. 2, the radio communication apparatus 11 has a transmitting unit 21 and a receiving unit 22.

The transmitting unit 21 includes an encoder 23, a block segmentation/subcarrier mapping unit 24, a known sequence generation/subcarrier mapping unit 26, IFFT/GI addition units 25 and 27, and a multiplexer 28. The transmitting unit 21 is an OFDM transmitter which selects subcarriers based on subcarrier selection information 36 fed back from the receiving unit 22 of an opposite apparatus.

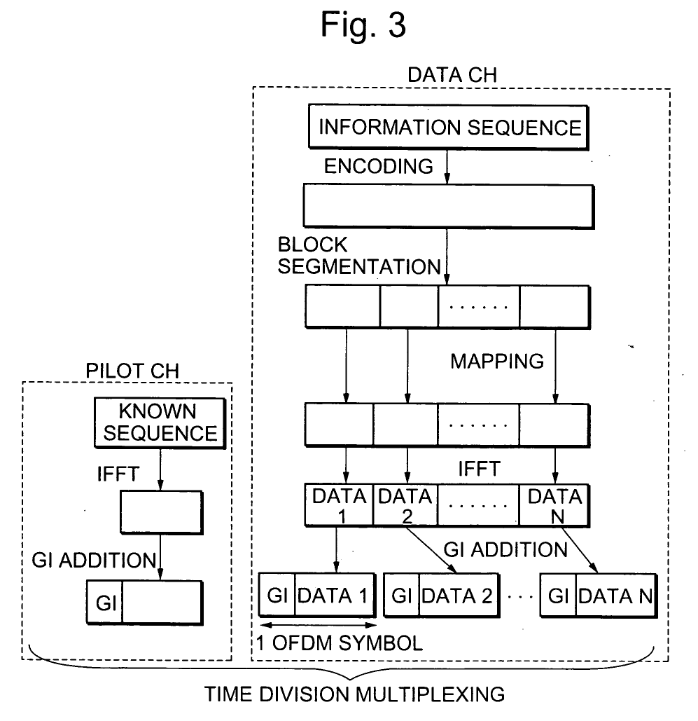

FIG. 3 shows the process of the transmitting unit according to the first exemplary embodiment.

As shown in FIG. 3, the transmitting unit 21 generates a data channel (DataCH) on which an information sequence of transmit data is mapped and a pilot channel (PilotCH) on which a known pilot signal is mapped, and time-division-multiplexes and transmits both the DataCH and the PilotCH. Referring to FIG. 2, the block segmentation/subcarrier mapping unit 24 and the IFFT/GI addition unit 25 are provided for the data channel (DataCH). The known sequence generation/subcarrier mapping unit 26 and the IFFT/GI addition unit 27 are provided for the pilot channel (PilotCH).

The encoder 23 receives an information sequence, and performs an encoding process, such as addition of error-correcting code, to the information sequence, and sends it to the block segmentation/subcarrier mapping unit 24.

The block segmentation/subcarrier mapping unit 24 selects subcarriers to be used, based on subcarriers election information 36 fed back from the receiving unit 22 of an opposite apparatus (not shown). Here, assume that the total number of subcarriers is C and the subcarriers are termed 1, 2, . . . , C in the order of lower-frequency subcarrier, and that the number of subcarriers selected as a subcarrier to be used is Q (C≧Q).

Also, the block segmentation/subcarrier mapping unit 24 segments data sent from the encoder 23 into blocks for each Q-number of symbols. Thereafter the block segmentation/subcarrier mapping unit 24 maps the Q-number of symbols onto the Q-number of subcarriers (in-use subcarrier) selected as the ones to be used, and maps “0” onto a portion corresponding to (C−Q)-number of subcarriers (idle subcarrier) not selected. This mapping process is performed on a per block basis.

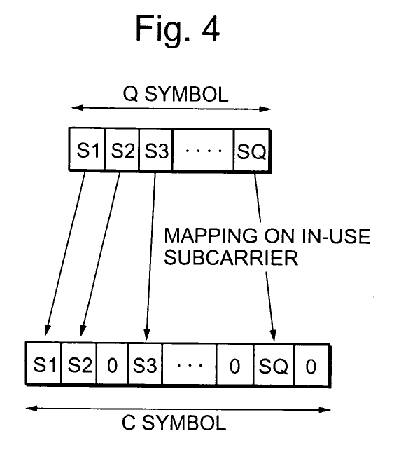

FIG. 4 shows the operation of the block segmentation/subcarrier mapping unit according to the first exemplary embodiment. Referring to FIG. 4, Q-number of symbols (S1 to SQ) are mapped onto Q-number of subcarriers to be used from among C-number of subcarriers, and “0” is mapped onto (C−Q)-number of subcarriers not to be used.

Accordingly, a block constituted of C-number of symbols is generated. The block segmentation/subcarrier mapping unit 24 sends the generated block to the IFFT/GI addition unit 25.

It is noted that before subcarrier selection information 36 is fed back, the block segmentation/subcarrier mapping unit 24 may randomly select the subcarriers to be used.

The IFFT/GI addition unit 25 performs an IFFT (Inverse Fast Fourier Transformation) process having C-number of analysis points to a block sent from the block segmentation/subcarrier mapping unit 24, and adds to the resultant C-number of symbols a GI with number-N symbols.

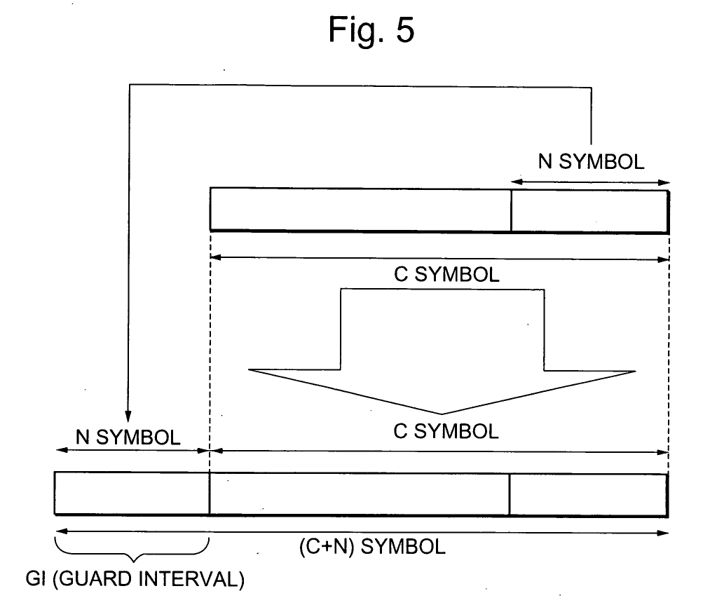

FIG. 5 shows the process of adding a GI. As shown in FIG. 5, the process of adding a GI is a process of copying from a series of N-number of symbols constituting the tail end of the block composed of C-number of symbols to the front of a block. Accordingly, data composed of (C+N)-number of symbols is generated. The IFFT/GI addition unit 25 sends the generated data to the multiplexer 28.

It is noted here that there is a clear distinction between a simpler term “symbol” and an “OFDM symbol”. An OFDM symbol means a group of data having added thereto an GI. A symbol means individual data obtained by encoding an information sequence.

The known sequence generation/subcarrier mapping unit 26, provided for the pilot channel, maps a known sequence onto C-number of subcarriers in one apparatus and an opposite apparatus thereof (not shown). The known sequence is, for example, data of symbols being all “1” or being all “1+j” (j being an imaginary number unit). Thereafter, the known sequence generation/subcarrier mapping unit 26 sends to the IFFT/GI addition unit 27 a block obtained by mapping a known sequence.

Similarly to the IFFT/GI addition unit 25 for the data channel, the IFFT/GI addition unit 27 performs an IFFT process having C-number of analysis points for data sent from the known sequence generation/subcarrier mapping unit 26, and further adds a GI composed of Np-number of symbols to the data.

Accordingly, data composed of (C+Np)-number of symbols is generated. The IFFT/GI addition unit 27 sends the generated data to the multiplexer 28.

The length of the GI (Np symbols) of the pilot channel is defined separately from that of the GI (N symbols) of the data channel. When the length of the GI of the pilot channel is shorter than a maximum a delay time of delayed wave, a block corresponding to the pilot channel may be interfered with by a preceding block, and-a channel estimation value (CH estimation value) thereof cannot be accurately determined. Thus, the length of the GI of the pilot channel is a preferably equal to or greater than a maximum delay time of a delayed wave. More specifically, when a maximum delay time of delayed wave is L [symbols], it is preferable that Np≧L.

The multiplexer 28 time-division-multiplexes a data channel sent from the IFFT/GI addition unit 25 and a pilot channel sent from the IFFT/GI addition unit 27 and sends the channels that have been multiplexed to an opposite apparatus.

Meanwhile, the receiving unit 22 includes a timing detection unit 29, a GI elimination/FFT unit 30, a channel estimation unit 31, a delay time determination/in-use subcarrier setting unit 32, a switch 33, an elimination filter coefficient calculation/interference elimination unit 34, and an equalizer/decoder 35.

The timing detection unit 29 detects timing information from a data sequence received from the opposite apparatus and sends the received data and the timing information to the GI elimination/FFT unit 30.

The GI elimination/FFT unit 30 identifies the position of the GI within the received signal based on the timing information sent from the timing detection unit 29, and eliminates the GI from the received signal. Further, the GI elimination/FFT unit 30 performs an FFT (Fast Fourier Transformation) process on the received signal from which the GI has been eliminated, to separate the pilot channel and data channel, which have been time-division-multiplexed on the received signal. Thereafter, the GI elimination/FFT unit 30 sends the pilot channel to the channel estimation unit 31, and the data channel to the switch 33.

The channel estimation unit 31 performs a channel estimation process by using the known sequence as a pilot channel, and sends the obtained channel estimation value to the delay time determination/in-use subcarrier setting unit 32 along with the timing information.

Here, the channel estimation value means a propagation path frequency characteristics value of each carrier, and more specifically, means a value obtained by dividing by a known sequence (“1” or “1+j” in the above described example), each subcarrier data obtained after the FFT process is performed by the GI elimination/FFT unit 30. Accordingly, the channel estimation value is composed of data corresponding to the number of subcarriers (C number).

The delay time determination/in-use subcarrier setting unit 32 generates a delay profile of the propagation path, for example, by applying an IFFT process to the channel estimation value. The delay profile of propagation path means information indicating the relationship between the delay time and the level of a delayed wave. The timing and level of an incoming delayed wave can be identified from the delay profile of the propagation path. The delay time determination/in-use subcarrier setting unit 32 determines, based on the delay profile, whether or not a delayed wave exceeding a GI exists. More specifically, the delay time determination/in-use subcarrier setting unit 32 determines whether or not a maximum delay time (L [symbol])>the length of the data channel GI (N [symbol]). If L>N, then it may mean that a delayed wave exceeding a GI exists. If N≧L, then it may mean that no delayed wave exceeding a GI exists.

When a delayed wave exceeding a GI exists, the delay time determination/in-use subcarrier setting unit 32 calculates a length T (=L−N) [symbol] of a maximum delay time of a delayed wave exceeding a GI, and selects (C−T)-number of subcarriers, and feeds back the information about the subcarriers as subcarrier selection information 37 to the transmitting unit 21 of the opposite apparatus. Assume that, according to the present exemplary embodiment, a method for selecting (C−T)-number of subcarriers is employed by which (C−T)-number of subcarriers having a large gain in the channel estimation value are selected. However, the present invention is not limited to this method. (C−T)-number of subcarriers may be selected by another method. For example, subcarriers having a small gain in the channel estimation value may be selected, or alternatively, subcarriers having a medium gain may be selected.

Meanwhile, when no delayed wave exceeding a GI exists, the delay time determination/in-use subcarrier setting unit 32 selects all C-number of subcarriers and feeds back the subcarriers as subcarrier selection information 37 to the transmitting unit 21 of the opposite apparatus.

When no delayed wave exceeding a GI exists, or when a delayed wave exceeding a GI exists and at the same time the number of idle subcarriers which have not been selected at this time, is smaller than T (=L−N), the delay time determination/in-use subcarrier setting unit 32 causes the switch 33 to select a terminal 33a. Accordingly, the data channel sent from the GI elimination/FFT unit 30 and the channel estimation value sent from the delay time determination/in-use subcarrier setting unit 32 are directly sent to the equalizer/decoder 35.

Meanwhile, when a delayed wave exceeding a GI exists and at the same time the number of idle subcarriers which have not been selected at this time, is equal to or greater than T (=L−N), the delay time determination/in-use subcarrier setting unit 32 causes the switch 33 to select a terminal 33b. Accordingly, the received data sent from the GI elimination/FFT unit 30 is sent to the interference elimination filter coefficient calculation/interference elimination unit 34.

The interference elimination filter coefficient calculation/interference elimination unit 34 calculates an interference elimination filter coefficient, eliminates interblock interference contained in the data channel by using the interference elimination filter coefficient and sends to the equalizer/decoder 35 data having eliminated therefrom the interblock interference. This process of eliminating interblock interference utilizes the fact that “0” has been inserted in the idle subcarriers, and is a process of estimating an interference component leaked into the in-use subcarriers from a component emerging in the idle subcarriers, and eliminating the interference component. Specifically, the interference elimination filter coefficient calculation/interference elimination unit 34 multiplies data sent from the GI elimination/FFT unit 30 by the interference elimination filter coefficient and thereby eliminates the interference.

The interference elimination filter coefficient used in this process is provided by Equation 1. The calculation of interference elimination filter W is described later.
W=P₁¹P₁(I−F′(P₂F′)⁻¹P₂) [Equation 1]

In Equation 1, W denotes an interference elimination filter coefficient matrix.

P₁ denotes a Q×C matrix representing in-use subcarriers. If k=1, 2, . . . , Q, then in the k-throw of P₁, only column component corresponding to the k-th smaller number from among the in-use subcarrier numbers is “1” and the other components are “0” The character “t” affixed to the matrix indicates transposition. For example, p₁^{t} of Equation 1 indicates a transposed matrix of P₁. The same is applied to the following equations.

For example, if the total number C of subcarriers is 4 and the number Q of in-use subcarriers is 2, then P₁ is a 2×4 matrix. Specifically, if four subcarrier numbers are 1, 2, 3 and 4, and two in-use subcarrier numbers are 1 and 3, then only the (1, 1) component and the (2, 3) component are “1” and the other components are all “0”. Consequently, in this example, P₁ is expressed as Equation 2.

$${P}_{1} = [ \begin{matrix}1 & 0 & 0 & 0 \\ 0 & 0 & 1 & 0\end{matrix} ] \qquad [ Equation 2 ]$$

P₂ denotes a (C−Q)×C matrix representing idle subcarriers. If k=1, 2, . . . , C−Q, then in the k-th row of P₂, only the column component corresponding to the k-th smaller number from among the idle subcarrier numbers is “1” and the other components are “0”.

For example, if the total number C of subcarriers is 4 and the number Q of in-use subcarriers is 2, then P2 is a 2×4 matrix. Specifically, if the four subcarrier numbers are 1, 2, 3 and 4, and the two in-use subcarrier numbers are 2 and 4, then only the (1, 2) component and the (2, 4) component are “1” and the other components are all “0”. In this example, P₂ is expressed as Equation 3.

$${P}_{2} = [ \begin{matrix}0 & 1 & 0 & 0 \\ 0 & 0 & 0 & 1\end{matrix} ] \qquad [ Equation 3 ]$$

I denotes a C×C unit matrix.

F′ denotes a C×(C−Q) matrix obtained by extracting (C−Q) columns from the farthest left column of an FFT matrix F having C-number of analysis points. This FFT matrix F having C-number of analysis points is a C×C matrix in which the (k, m)-th component (k=1, 2, . . . , C, m=1, 2, . . . , C) is exp (−j2π×(k−1)×(m−1)/C); j is an imaginary number unit.

Interblock interference elimination using the interference elimination filter coefficient W is performed based on Equation 4.
d=Wr [Equation 4]

In Equation 4, d denotes a data vector after the interference elimination is performed. This vector d is a C-dimensional column vector, and the-k-th component thereof (k=1, 2, . . . , C) is data having eliminated therefrom interference data corresponding to subcarrier number k (k=1, 2, . . . , C). Q-number of components corresponding to in-use subcarrier numbers are extracted from among the vector d and sent to the equalizer/decoder 35.

The character r denotes a C-dimensional column vector and is obtained by segmenting the received data sent from the GI elimination/FFT unit 30 for each block of C-number of symbols.

The equalizer/decoder 35 receives a data channel and channel estimation value and performs an equalizing/decoding process to extract an information sequence. As described above, the data channel used herein is supplied directly from the GI elimination/FFT unit 30 or supplied after an interference elimination process is performed thereto by the interference elimination filter coefficient calculation/interference elimination unit 34.

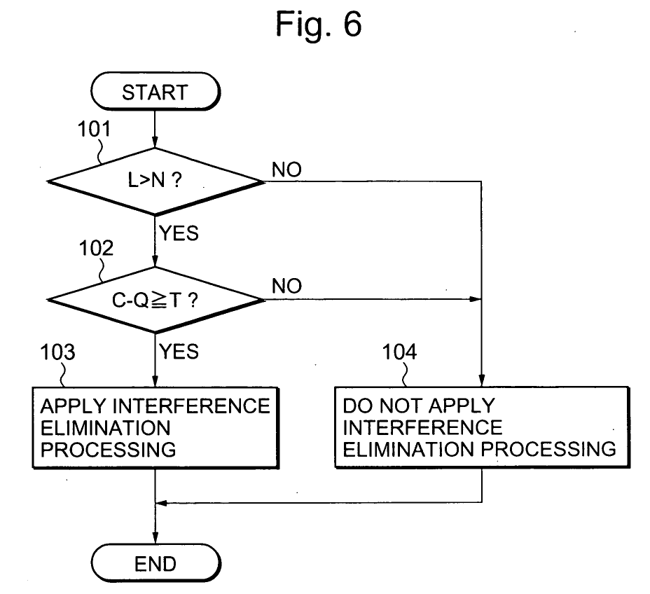

FIG. 6 is a flowchart showing an example of an interference elimination operation by the receiving unit of the radio communication apparatus according to the present exemplary embodiment. Referring to FIG. 6, first, the delay time determination/in-use subcarrier setting unit 32 determines whether or not a maximum delay time of a delayed wave is greater than the length of the GI of the data channel, i.e., L>N (101).

If L>N, the delay time determination/in-use subcarrier setting unit 32 the determines whether or not the number of idle subcarriers is equal to or greater than the number of symbols corresponding to a length of a maximum delay time exceeding a GI, i.e., C−Q≧T (102).

If C−Q≧T, the delay time determination/in-use subcarrier setting unit 32 causes the switch 33 to select the terminal 33b, and thus the process by the interference elimination filter coefficient calculation/interference elimination unit 34 is applied to the data channel (103).

Meanwhile, if it is determined in operation 101 that L>N is not satisfied, or if it is determined in operation 102 that C−Q≧T is not satisfied, the delay time determination/in-use subcarrier setting unit 32 causes the switch 33 to select the terminal 33a, and thus the process by the interference elimination filter coefficient calculation/interference elimination unit 34 is not performed on the data channel (104).

As described above, in the radio communication system according to the present exemplary embodiment, the radio communication apparatus in the transmitting side selects subcarriers to be used based on the subcarrier selection information 36 fed back from the radio communication apparatus in the receiving side, and maps symbols onto the subcarriers selected for use, and “0” onto the other subcarriers. The radio communication apparatus in the receiving side determines whether or not a delayed wave exceeding a GI is contained in a received signal from the radio communication apparatus in the transmitting side, and if so, determines the number of idle subcarriers according to a length of a maximum de-lay exceeding a GI and feeds back subcarrier information to the radio communication apparatus in the transmitting side, and eliminates an interference component of the delayed wave from the received signal from the radio communication apparatus in the transmitting side by utilizing the fact that “0” has been inserted in the idle subcarriers.

Accordingly, in the radio communication system according to the present exemplary embodiment, the radio communication apparatus in the transmitting side inserts “0” into the idle subcarriers and the radio apparatus in the receiving side eliminates an interference component of delayed wave from a received signal by utilizing the presence of idle subcarriers having “0” inserted therein. And it is possible to determine interference caused by a delayed wave based on leakage into idle subcarriers originally having “0” to satisfactorily eliminate the interference. In the Orthogonal Frequency Division Multiplexing modulation system, the presence of a delayed wave causes leakage among subcarriers orthogonal to each other. In this case, some value emerges in idle subcarriers originally having “0”. By utilizing this, interblock interference caused by a delayed wave can be estimated.

Also, in the radio communication system according to the present exemplary embodiment, the radio communication apparatus in the receiving side determines, based on a delay time of the delayed wave, whether or not to perform interference elimination. Thus, when a delay time of the delayed wave is long and then interference is caused by the delayed wave, the elimination process is performed to satisfactorily eliminate the interference.

Also, in the radio communication system according to the present exemplary embodiment, the radio communication apparatus in the receiving side determines, based on a delay profile generated from a received signal, whether or not a delayed wave exceeding a GI exists. If so, when idle subcarriers exist that are equal to or greater than corresponding to a length of a maximum delay time exceeding a GI, delayed wave components are eliminated by using the idle subcarriers. Thus, in communications using a GI, when interference is caused by a delayed wave exceeding a GI, the process is performed so that the interference can be satisfactorily eliminated.

Also, in the radio communication system according to the present exemplary embodiment, the number of in-use subcarriers and the arrangement thereof can be adaptively controlled according to a maximum delay time of the propagation path and a channel estimation value. Thus, interblock interference can be satisfactorily eliminated without varying the GI even when the delay time varies, allowing reception with satisfactory characteristics.

As the encoding scheme used in the encoder 23 and the equalizer/decoder 35, a variety of schemes are possible. However, selection of one from among them does not influence the nature of the present invention.

In the present exemplary embodiment, there is described a case in which the present invention is applied to communication based on the Orthogonal Frequency Division Multiplexing system using a GI. However, the present invention is not limited thereto. Even with a system not using a GI, when the present invention is applied to the system, interblock interference can be eliminated as with the present exemplary embodiment.

A second exemplary embodiment will be described with reference to the drawings. The difference between the second exemplary embodiment and the first exemplary embodiment lies in that the transmitting unit of the radio communication apparatus determines the number of in-use subcarriers and numbers thereof in a fixed manner without receiving subcarrier selection information from the receiving unit of an opposite apparatus. The number of in-use subcarriers and the subcarrier numbers are determined according to a maximum delay time based on the state of the propagation path preliminarily measured.

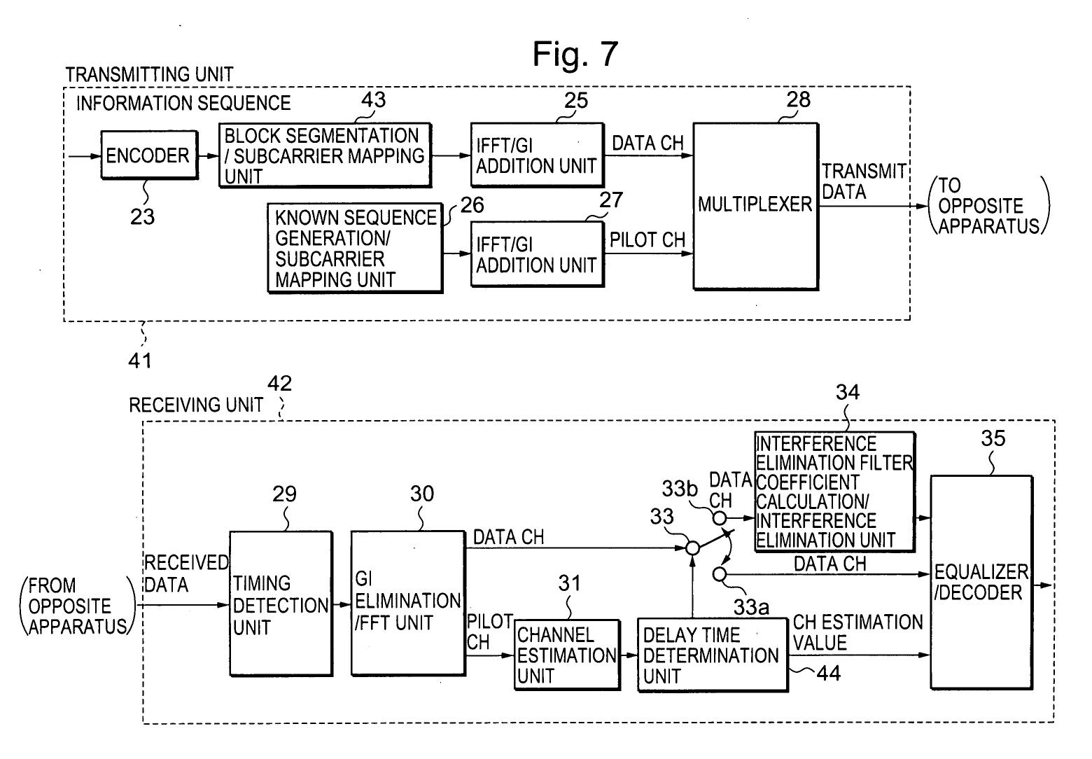

FIG. 7 is a block diagram showing a configuration of a radio communication apparatus according to the second exemplary embodiment. Referring to FIG. 7, the radio communication apparatuses 11 and 12 have the same configuration, and hence the radio communication apparatus 11 is shown here as representative.

Referring to FIG. 7, the radio communication apparatus 11 has a transmitting unit 41 and a receiving unit 42.

The transmitting unit 41 includes an encoder 23, a block segmentation/subcarrier mapping unit 43, a known sequence generation/subcarrier mapping unit 26, IFFT/GI addition units 25 and 27, and a multiplexer 28. The encoder 23, the known sequence generation/subcarrier mapping unit 26, the IFFT/GI addition units 25 and 27, and the multiplexer 28 may be the same as those of the first exemplary embodiment shown in FIG. 2.

The difference between the block segmentation/subcarrier mapping unit 43 and the block segmentation/subcarrier mapping unit 24 of the first exemplary embodiment lies in that the unit 43 determines the number of in-use subcarriers and numbers thereof in a fixed manner without receiving subcarrier selection information from the receiving unit of an opposite apparatus. In the block segmentation/subcarrier mapping unit 43, there is stored the predetermined number T of in-use subcarriers and the subcarrier numbers preliminarily set commonly for the receiving unit of the opposite apparatus and the other apparatus when a link setting is performed.

By using the predetermined number of subcarriers and the subcarrier numbers, the transmitting unit 41 performs in the similar manner as that of the first exemplary embodiment.

Meanwhile, the receiving unit 42 includes a timing detection unit 29, a GI elimination/FFT unit 30, a channel estimation unit 31, a delay time determination unit 44, a switch 33, an elimination filter coefficient calculation/interference elimination unit 34, and an equalizer/decoder 35.

The timing detection unit 29, the. GI elimination/FFT unit 30, the channel estimation unit 31, the switch 33, the elimination filter coefficient calculation/interference elimination unit 34 and the equalizer/decoder 35 may be the same as those of the first exemplary embodiment shown in FIG. 2.

The difference between the delay time determination unit 44 and the delay time determination/in-use subcarrier setting unit 32 lies in that the unit 44 does not have a function of selecting in-use subcarriers and feeding them back to the opposite apparatus.

The delay time determination unit 44 measures a maximum delay time, determines whether or not it exceeds the GI, and according to the result, changes the state of the switch 33.

As described above, according to the present exemplary embodiment, the number of in-use subcarriers and the arrangement thereof set in a fixed manner are used; when there exists a delayed wave exceeding a GI, the radio communication apparatus in the receiving side eliminates the delayed wave component from the received signal by utilizing the presence of idle subcarriers having “0” mapped thereon. Accordingly, in a system having a small variation in maximum delay time, it is possible to satisfactorily eliminate interblock interference caused by the influence of a delayed wave exceeding a GI with a simple configuration and control.

A third exemplary embodiment will now be described.

In the first and second exemplary embodiments, the length Np of the pilot channel GI may be different from the length N of the data channel GI. However, in the third exemplary embodiment, it is assumed that these GI have the same length. A radio communication apparatus according to the third exemplary embodiment has the same configuration as that of the first or second exemplary embodiment, and only the operation of the IFFT/GI addition unit 27 is different.

According to the present exemplary embodiment, similarly to the IFFT/GI addition unit 25 for data channel, the IFFT/GI addition unit 27 for the pilot channel adds a GI of N-number of symbols.

According to the present exemplary embodiment, the length of the GI assigned to pilot channel is reduced and an additional length can be used for data channel transmission, thus enabling an effective use of resources.

According to the present exemplary embodiment, a maximum delay time L of the delayed wave may exceed a length N of the pilot channel GI. When a delayed wave exceeds a GI, the pilot channel is subjected to interblock interference, deteriorating the channel estimation accuracy. However, the channel estimation accuracy can be improved by using a diversity antenna with plural antennas for reception.

For example, a maximum delay time may be measured for each reception antenna, and a channel estimation value which is obtained from a signal received from an antenna in which no delayed wave exceeding a GI is detected may be used. Also, if a delayed wave exceeding a GI is detected from received signals of all the antennas, when a channel estimation value may be used which is obtained from a received signal of an antenna having a smallest delay time, whereby accuracy deterioration can be reduced.

A fourth exemplary embodiment will now be described.

In the first exemplary embodiment, “0” is inserted in (C−Q)-number of subcarriers which are not selected. However, the present invention is not limited thereto. The value inserted in subcarriers not selected may be known in the apparatuses in the transmitting side and the receiving side. In this case, the apparatus in the receiving side may eliminate interference by utilizing the fact that a known value has been inserted in subcarriers which are not selected.

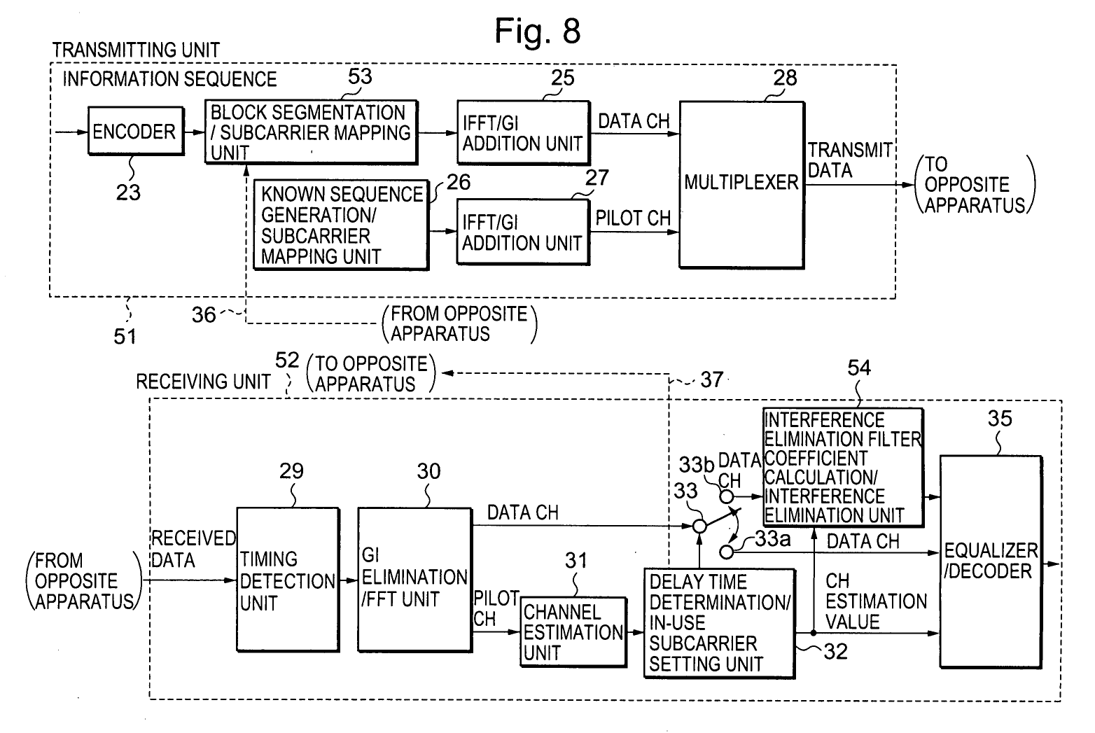

FIG. 8 is a block diagram showing a configuration of a radio communication apparatus according to a fourth exemplary embodiment. Referring to FIG. 8, the radio communication apparatus includes a transmitting unit 51 and a receiving unit 52.

The transmitting unit 51 includes an encoder 23, a block segmentation/subcarrier mapping unit 53, a known sequence generation/subcarrier mapping unit 26, IFFT/GI addition units 25 and 27, and a multiplexer 28. The encoder 23, the known sequence generation/subcarrier mapping unit 26, the IFFT/GI addition units 25 and 27, and the multiplexer 28 may be the same as those of the first exemplary embodiment shown in FIG. 2.

The difference between the block segmentation/subcarrier mapping unit 53 and the block segmentation/subcarrier mapping unit 24 lies in that a known value is inserted in idle subcarriers. This value is known in both the radio communication apparatus and the opposite apparatus.

The transmitting unit 51 operates similarly to that of the first exemplary embodiment except that a known value is inserted in idle subcarriers.

Meanwhile, the receiving unit 52 includes a timing detection unit 29, a GI elimination/FFT unit 30, a channel estimation unit 31, a delay time determination/in-use subcarrier setting unit 32, a switch 33, an elimination filter coefficient calculation/interference elimination unit 54 and an equalizer/decoder 35.

The timing detection unit 29, the GI elimination/FFT unit 30, the channel estimation unit 31, the delay time determination/in-use subcarrier setting unit 32, the switch 33 and the equalizer/decoder 35 may be the same as those of the first exemplary embodiment shown in FIG. 2.

The difference between the elimination filter coefficient calculation/interference elimination unit 54 and that of the first exemplary embodiment shown in FIG. 2 lies in that after a known value component mapped on idle subcarriers is subtracted from a data channel supplied from the GI elimination/FFT unit 30, interblock interference is eliminated by using the interference elimination filter coefficient.

The received signal component of a known value mapped on idle subcarriers and then transmitted is the result of receiving the known value inserted by the transmitting unit of the opposite apparatus via a propagation path, and thus obtained by multiplying by the known value a channel estimation value being the result of estimating the propagation path characteristics.

The interference elimination filter coefficient used to eliminate interblock interference may be the same as that of the first exemplary embodiment expressed as Equation 1.

As described above, in the radio communication system of the present exemplary embodiment, the radio communication apparatus in the transmitting side inserts a known value in idle subcarriers, and the radio communication apparatus in the receiving side performs an interference elimination process after subtracting from a data channel a known value component being received through a propagation path Accordingly, even when a variety of known values not equal to “0” are used as the value inserted in idle subcarriers, interference elimination caused by the influence of a delayed wave exceeding-a GI may be satisfactorily eliminated as with the first exemplary embodiment.

The derivation of an interference elimination filter W value used in each of the above described exemplary embodiments will now be described.

Here, to derive an interference elimination filter W, the following variables are defined in addition to the variables contained in Equation 1.

hᵢ (i=0, 1, 2, . . . , L) denotes a temporal response of a delayed wave which arrives with a delay corresponding to number-i of symbols. Herein, i=0 indicates an incoming wave with no delay, i.e., a direct wave.

d (k) denote a C-dimensional column vector obtained by arranging transmit symbols (i.e., a symbol corresponding to one OFDM symbol) of a block from which interference is to be eliminated, in the order of smaller subcarrier number.

d (k−1) denotes a C-dimensional column vector obtained by arranging transmit symbols of a block preceding a block from which interference is to be eliminated, in the order of smaller subcarrier number.

d₁ (k) denotes a Q-dimensional column vector obtained by arranging Q-number of symbols to be mapped on in-use subcarriers contained in a block from which interference is to be eliminated, in the order of smaller subcarrier number.

d₂ (k) denote a (C−Q)-dimensional column vector obtained by arranging (C−Q)-number of known symbols to be mapped on idle subcarriers contained in a block from which interference is to be eliminated, in the order of smaller subcarrier number. For example, when “0” is mapped on idle subcarriers, all the elements are “0”.

A denotes a diagonal matrix in which the diagonal components, i.e., the (i, i)-th components (i=0, 1, 2, . . . , C) are a channel response of the i-th subcarrier and the other components are all “0”. This A is a C×C matrix indicating a channel estimation value.

H_{IBI} denotes a C×C matrix in which the (m, C−L+N+m+k)-th components are h_{L-k} (k=0, 1, 2, . . . , L−N−1; m=1, 2, . . . , L−N−k) and the other components are all “0”. H_{IBI} is expressed as Equation 5.

$${H}_{IBI} = [ \begin{matrix} & {h}_{L} & ⋯ & {h}_{N + 2} & {h}_{N + 1} \\ & & ⋰ & & {h}_{N + 2} \\ & & & ⋰ & ⋮ \\ & & & & {h}_{L} \\ 0 & & & & \end{matrix} ] \qquad [ Equation 5 ]$$

H denotes a C×C matrix and is a Toeplitz matrix in which the first row is [h₀, 0, . . . , 0, h_{L}, 0, . . . , h₂, h₁] and the k-th row (k=0, 1, 2, . . . , C) is a value obtained by rotating right the first row by (k−1)-number of components. H is expressed as Equation 6.

$$H = [ \begin{matrix}{h}_{0} & 0 & 0 & ⋯ & ⋯ & 0 & {h}_{L} & ⋯ & {h}_{N} & ⋯ & {h}_{2} & {h}_{1} \\ {h}_{1} & {h}_{0} & ⋰ & & & & 0 & ⋰ & & ⋰ & & {h}_{2} \\ & {h}_{1} & ⋰ & ⋰ & & & & ⋰ & ⋰ & & ⋰ & ⋮ \\ {h}_{N} & & ⋰ & ⋰ & ⋰ & & & & ⋰ & ⋰ & & {h}_{N} \\ & ⋰ & & ⋰ & ⋰ & ⋰ & & 0 & & ⋰ & ⋰ & ⋮ \\ {h}_{L} & & ⋰ & & ⋰ & ⋰ & ⋰ & & & & ⋰ & {h}_{L} \\ 0 & ⋰ & & ⋰ & & ⋰ & ⋰ & ⋰ & & & & 0 \\ & ⋰ & ⋰ & & ⋰ & & ⋰ & ⋰ & ⋰ & & & ⋮ \\ & & ⋰ & ⋰ & & ⋰ & & ⋰ & ⋰ & ⋰ & & ⋮ \\ & & & ⋰ & ⋰ & & ⋰ & & ⋰ & ⋰ & ⋰ & ⋮ \\ & 0 & & & ⋰ & ⋰ & & ⋰ & & ⋰ & ⋰ & 0 \\ & & & & & 0 & {h}_{1} & ⋯ & {h}_{N} & ⋯ & {h}_{1} & {h}_{0}\end{matrix} ] \qquad [ Equation 6 ]$$

S_{N} denotes a C×C matrix in which the (N+i, i)-th component (i=1, 2, . . . , C−N) and the (i, C−N+1)-th component (i=1, 2, . . . , N) are “1” and the other components are all “0”. S_{N} is expressed as Equation 7.

$${S}_{N} = [ \begin{matrix} & & & & & & 1 & & & \\ & & & & & & & ⋰ & 0 & \\ & & & & & & & & ⋰ & \\ & & & & & & & & & 1 \\ & & & & & 0 & & & & \\ 1 & & & & & & & & & \\ & ⋰ & & & & & & & & \\ & & ⋰ & & & & & & & \\ & 0 & & ⋰ & & & & & & \\ & & & & 1 & & & & & \end{matrix} ] \qquad [ Equation 7 ]$$

Also, as for these matrices defined, relationships shown in Equation 8 and Equation 9 hold.
d(k)=P₁^{t}d₁(k)+P₂^{t}d₂(k) [Equation 8]
H=F⁻¹ΛF [Equation 9]

Data r obtained by eliminating the GI and performing an FFT process in the GI elimination/FFT unit 30 may be expressed as Equation 10 by using these variables. Here, it is assumed that a block from which interference is to be eliminated is subjected to interference from an immediately preceding block.
r=FH_{IBI}F⁻¹d(k−1)+F(H−H_{IBI}S_{N})F⁻¹d(k) [Equation 10]

The first term in the right-hand side of Equation 10, i.e., FH_{IBI} F⁻¹d(k−1) is an interference component from an immediately preceding block of the block from which interference is to be eliminated. The second term i.e., F(H−H_{IBI} S_{N})F⁻¹d(k) is the component of the block from which interference is to be eliminated.

This r includes the component of in-use subcarriers and that of idle subcarriers. Thus, firstly the component of the known value mapped on the idle subcarriers is subtracted from r. The component of the idle subcarriers to be subtracted may be expressed as ΛP₂^{t}d₂(k) by using channel estimation value A.

It is noted that the process of subtracting a known value component from a data channel in the fourth exemplary embodiment may be an equivalent to a process of subtracting from data r containing a known value component, ΛP₂^{t}d₂ (k) being the component of known value d₂(k) which is received through the propagation path estimated to have a channel estimation value A.

When “0” is mapped on idle subcarriers, the known value component passing through the propagation path is “0”. Thus this subtraction is unnecessary.

When Equation 8 and Equation 9 are applied to the subtraction result, Equation 11 is provided.
r−ΛP₂′d₂(k)=FH_{IBI}F⁻¹d(k−1)+F(HF⁻¹P₁′d₁(k)−H_{IBI}S_{N}F⁻¹d(k)) [Equation 11]

With respect to Equation 11, when interference from an immediately preceding block is eliminated by the interference elimination filter W, simultaneous equations composed of Equation 12 and Equation 13 are provided.
P₁WFH_{IBI}=0 [Equation 12]
P₁WF(HF⁻¹P₁^{t}d₁(k)−H_{IBI}S_{N}F⁻¹d(k))=P₁ΛP₁^{t}d₁(k) [Equation 13]

In Equation 12, 0 denotes a Q×C matrix whose components are all 0.

When the simultaneous equations composed of Equation 12 and Equation 13 are solved, the interference elimination filter coefficient matrix W is determined by using Equation 1 described above.

While this invention has been particularly shown and described with reference to exemplary embodiments thereof, it will be understood by those skilled in the art that various changes in form and details may be made therein without departing from the spirit and scope of the invention as defined by the appended claims. The above-described exemplary embodiments should be considered in a descriptive sense only and are not for purposes of limitation. Therefore, the scope of the invention is defined not by the detailed description of the invention but by the appended claims, and all differences within the scope will be construed as being included in the present invention.

What we claim is:

1. A radio communication system comprising:
a transmitting unit, comprising:
a mapping circuit which generates a data channel which has a known value inserted in idle subcarriers; and
a transmitter which transmits a radio signal including the data channel;
a receiving unit, comprising:
a receiver which receives the radio signal from the transmitting unit; and
an interference eliminator which eliminates a delayed wave component from the data channel based on the known value inserted in the idle subcarriers.

2. The radio communication system according to claim 1, wherein the interference eliminator determines whether or not to eliminate the delayed wave component based on a delay time of a delayed wave of the radio signal.

3. The radio communication system according to claim 2, wherein the transmitting unit further comprises a guard interval adder which adds a guard interval to the data channel, the receiving unit further comprises a channel estimator which generates a delay profile from the radio signal received, and the interference eliminator determines whether or not a delayed wave exceeds the guard interval and, eliminates the delayed wave component from the data channel based on the known value inserted in the subcarriers if the delayed wave exceeds the guard interval and if enough idle subcarriers exist for delay time exceeding the guard interval.

4. The radio communication system according to claim 3, wherein the receiving unit, in the case where a delayed wave exceeds the guard interval, transmits a feed back signal for subcarrier selection for interference elimination process for the delay waves exceeding the guard interval, and the transmitting unit sets in-use subcarriers and idle subcarriers according to the feed back signal.

5. The radio communication system according to claim 1, wherein the interference elimination process is based on the estimation of an interference component leaked into in-use subcarriers from the idle subcarriers.

6. The radio communication system according to claim 1, wherein the interference elimination process multiplies the received data channel by an-interference elimination filter matrix obtained from a matrix representing in-use subcarriers, a matrix representing idle subcarriers and an FFT matrix having the number of analysis points equal to the total number of subcarriers.

7. The radio communication system according to claim 1, wherein the interference elimination process is performed after eliminating the component corresponding to the known value from the received data channel.

8. The radio communication system according to claim 1, wherein the known value is zero.

9. The radio communication system according to claim 1, wherein the transmitting unit multiplexes a pilot channel onto the data channel and a number of symbols of a guard interval of the pilot channel is the same as the data channel.

10. A radio communication apparatus comprising:
a transmitting unit, comprising:
a mapping circuit which generates a data channel which has a known value inserted in idle subcarriers; and
a transmitter which transmits a radio signal including the data channel;
a receiving unit, comprising:
a receiver which receives the radio signal from the transmitting unit; and
an interference eliminator which eliminates a delayed wave component from the data channel based on the known value inserted in the idle subcarriers.

11. The radio communication apparatus according to claim 10, wherein the interference eliminator determines whether or not to eliminate the delayed wave component based on a delay time of a delayed wave of the radio signal.

12. The radio communication apparatus according to claim 11, wherein the transmitting unit further comprises a guard interval adder which adds a guard interval to the data channel, the receiving unit further comprises a channel estimator which generates a delay profile from the radio signal received, and the interference eliminator determines whether or not a delayed wave exceeds the guard interval and, eliminates the delayed wave component from the data channel based on the known value inserted in the subcarriers if the delayed wave exceeds the guard interval and if enough idle subcarriers exist for delay time exceeding the guard interval.

13. The radio communication apparatus according to claim 12, wherein the receiving unit, in the case where a delayed wave exceeds the guard interval, transmits a feed back signal for subcarrier selection for interference elimination process for the delay waves exceeding the guard interval, and the transmitting unit sets in-use subcarriers and idle subcarriers according to the feed back signal.

14. The radio communication apparatus according to claim 10, wherein the interference elimination process is based on the estimation of an interference component leaked into in-use subcarriers from the idle subcarriers.

15. The radio communication apparatus according to claim 10, wherein the interference elimination process multiplies the received data channel by an interference elimination filter matrix obtained from a matrix representing in-use subcarriers, a matrix representing idle subcarriers and an FFT matrix having the number of analysis points equal to the total number of subcarriers.

16. The radio communication apparatus according to claim 10, wherein the interference elimination process is performed after eliminating the component corresponding to the known value from the received data channel.

17. The radio communication apparatus according to claim 10, wherein the known value is zero.

18. The radio communication apparatus according to claim 10, wherein the transmitting unit multiplexes a pilot channel onto the data channel and a number of symbols of a guard interval of the pilot channel is the same as the data channel.

19. A receiving apparatus comprising:
a receiver which receives a radio signal including a data channel in which a known value in subcarriers is inserted;
a determination unit which determines, based on a delay time of a delayed wave of the radio signal from a transmitting apparatus, whether or not to perform interference elimination,
an interference eliminator which eliminates, in response to the result of the determination unit, a delayed wave component of the data channel by an interference elimination process using the known value inserted in the idle subcarriers.

20. The receiving apparatus according to claim 19, wherein a guard interval is added to the data channel, and the determination unit generates a delay profile from the radio signal sent from the transmitting apparatus and determines whether or-not there is a delayed wave exceeding the guard interval based on the delay profile, and if there exist enough idle subcarriers for delay time exceeding the guard interval eliminates the delayed wave component.

21. The receiving apparatus according to claim 20, wherein the determination unit, in the case where a delayed wave exceeds the guard interval, transmits a feed back signal for subcarrier selection.

22. The receiving apparatus according to claim 19, wherein the interference eliminator eliminates based on the estimation of an interference component leaked into in-use subcarriers from the idle subcarriers.

23. The receiving apparatus according to claim 19, wherein the interference elimination process multiplies the received data channel by an interference elimination filter matrix obtained from a matrix representing in-use subcarriers, a matrix representing idle subcarriers and an FFT matrix having the number of analysis points equal to the total number of subcarriers.

24. The receiving apparatus according to claim 19, wherein the interference elimination process is performed after eliminating the component corresponding to the known value from the received data channel.

25. The receiving apparatus according to claim 19, wherein the known value is zero.

26. A radio communication method comprising:
generating a data channel which has a known value inserted in idle subcarriers;
transmitting a radio signal including the data channel;
receiving the radio signal; and
eliminating a delayed wave component from the data channel based on the known value inserted in the idle subcarriers.

27. The radio communication method according to claim 26, further comprising:
determining whether or not to eliminate the delayed wave component based on a delay time of a delayed wave of the radio signal.

28. The radio communication method according to claim 27, further comprising:
adding a guard interval to the data channel;
generating a delay profile from the radio signal;
determining whether or not a delayed wave exceeds the guard interval; and
determining whether or not there exist enough idle subcarriers for delay time exceeding the guard interval;
wherein, the delayed wave component from the data channel is eliminated based on the known value inserted in the subcarriers if the delay wave exceeds the guard interval and if enough idle subcarriers exist.

29. The radio communication method according to claim 28, further comprising:
transmitting a feed back signal for subcarrier selection; and
setting in-use subcarriers and idle subcarriers according to the feed back signal.

30. The radio communication method according to claim 26, the eliminating process further comprising:
estimating an interference component leaking into in-use subcarriers from the idle subcarriers; and
eliminating the interference component.

31. The radio communication method according to claim 26, the eliminating process further comprising:
multiplying the received data channel by an interference elimination filter matrix obtained from a matrix representing in-use subcarriers, a matrix representing idle subcarriers and an FFT matrix having the number of analysis points equal to the total number of subcarriers.

32. The radio communication method according to claim 26, the eliminating process further comprising:
eliminating the component corresponding to the known value from the received data channel.

33. The radio communication method according to claim 26, wherein the known value is zero.

34. The radio communication method according to claim 26, further comprising:
multiplexing a pilot channel onto the data channel before transmitting; and
wherein a number of symbols of a guard interval of the pilot channel is the same as the data channel.
